(19) United States
(12) Patent Application Publication
(10) Pub. No.: US 2008/0104657 A1
(43) Pub. Date: May 1, 2008

(54) DIGITAL BROADCAST RECEPTION DEVICE

(75) Inventor: Atsushi FURUKAWA, Gifu (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 11/923,981

(22) Filed: Oct. 25, 2007

(30) Foreign Application Priority Data
Oct. 26, 2006 (JP) 2006-291742

(51) Int. Cl. H04N 7/173

(52) U.S. Cl. 725/134

(57) ABSTRACT

A digital broadcast reception device comprises a tuner for receiving a digital broadcast to output a transport stream, a demultiplexer for separating packets from the transport stream, a decoder for decoding the packets to output data, an output section for outputting video and audio of a program based on the data obtained by the decoder, a recorder for recording video and audio data in a program being displayed at present or a transport stream containing video and audio data in a program being displayed at present, an information recording section for recording received partial information has been obtained or received partial information being obtained by reception broadcast at a time when the reception device receives an instruction to record from a user, a recording controller for relating the received partial information to a recorded content recorded by the recorder when the received partial information is recorded by the information recording section, the recorded content being a content of the broadcast that comes before and after or before or after the received partial information that is recorded, and a reproducing controller for showing the recorded received partial information and reproducing the recorded content recorded in the recorder.

### CROSS REFERENCE TO RELATED APPLICATIONS

This application is based upon and the benefit of priority from prior Japanese Patent Application No. 2006-291742 filed on Oct. 26, 2006, the entire contents of which are incorporated herein by reference.

### BACKGROUND OF THE INVENTION

The present invention relates to digital broadcast reception devices.

### DESCRIPTION OF THE RELATED ART

A digital broadcast reception device capable of recording television programs is known. Usually, when a user wishes to watch programs recorded by the digital broadcast reception device, the user causes the reception device to display a list of recorded programs on a display, for example, and selects the desired program (recorded video and audio data) from the list and starts to watch the selected television program video.

### SUMMARY OF THE INVENTION

In the digital broadcast reception device, it is possible to record only part of the television program or only collateral information in the television program without recording all of a television program. For example, it is possible to record still images on the television screen or, part or all of a data broadcast program included in a television program (TV show) as partial information.

However, after recording a scene of the received program, the user might forget which program (TV Show) is associated with the recorded scene or forget a story before and after the scene. Further, selling of commodities by using a data broadcast program incorporated in the television program that is being broadcast. However, even though images of commodities and linked pages for the commodity purchase, which are acquired from the data broadcast program, have been stored in the reception device, the user might forget a television program which is the program that the user intends to buy the commodities.

Therefore, it is desired that the digital broadcast reception device is constructed so as to be able to record the partial information in the received television program and so as to be able to show which television program is associated with the partial information.

A digital broadcast reception device according to the present invention comprises a tuner for receiving a digital broadcast to output a transport stream; a demultiplexer for separating packets from the transport stream; a decoder for decoding the packets to output data; an output section for outputting video and audio of a program based on the data obtained by the decoder; a recorder for recording video and audio data in a program being displayed at present or a transport stream containing video and audio data in a program being displayed at present; an information recording section for recording received partial information has been obtained or received partial information being obtained by reception broadcast at a time when the reception device receives an instruction to record from a user; a recording controller for relating the received partial information to a recorded content recorded by the recorder when the received partial information is recorded by the information recording section, the recorded content being a content of the broadcast that comes before and after or before or after the received partial information that is recorded; and a reproducing controller for showing the recorded received partial information and reproducing the recorded content recorded in the recorder.

In the digital broadcast reception device, the recording controller may acquire, from information included in the broadcast currently being received, character information indicating as to which program the received partial information belongs to, and relate the character information to the received partial information.

In the digital broadcast reception device, the received partial information may be an image that is captured at a time when the reception device receives an instruction to record from a user. Furthermore, the received partial information may be at least one of specification information existing in a data broadcast program, link information existing in the specification information, and location information existing in the specification information. Furthermore, the received partial information may be information that is downloaded using the broadcast currently being received.

The digital broadcast reception device may display a list that relates the received partial information to the recorded content.

In the digital broadcast reception device, the reproducing controller may automatically display the recorded content related to the received partial information when the received partial information is displayed or is selected by user's operation. Or the reproducing controller may display a message indicating that the recorded content according to the received partial information is saved, when the received partial information is displayed or is selected by user's operation, and display the recorded content when an operation indicating that the user wishes to view the recorded content is performed by the user.

With the digital broadcast reception device, in connection with the saving of the received partial information (a partial saved file), the recorded content (a reference file) that comes before and after or before or after the received partial Information is recorded, and the received partial information and the recorded content are related with each other and are recorded. Therefore, it is possible to reproduce the recorded content (the reference file) in conjunction with the reproducing of the received partial information (the partial saved file), and a user can remember the reason why the received partial information (the partial saved file) was saved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a digital broadcast reception device according to an embodiment of the present invention.

FIG. 2 is a flow chart showing content of processing according to an embodiment of the present invention.

FIG. 3 is an illustrative diagram showing an example of linking recording according to an embodiment of the present invention.

FIG. 4 is an illustrative diagram showing an example of displaying on a screen according to an embodiment of the present invention.

FIG. 5 is an illustrative diagram showing an example of displaying on a screen according to an embodiment of the present invention.

FIG. 6 is an illustrative diagram showing an example of displaying on a screen according to an embodiment of the present invention.

FIG. 7 is an illustrative diagram showing an example of displaying on a screen according to an embodiment of the present invention.

FIG. 8 is an illustrative diagram showing an example of displaying on a screen according to an embodiment of the present invention.

### DESCRIPTION OF THE PREFERRED EMBODIMENTS

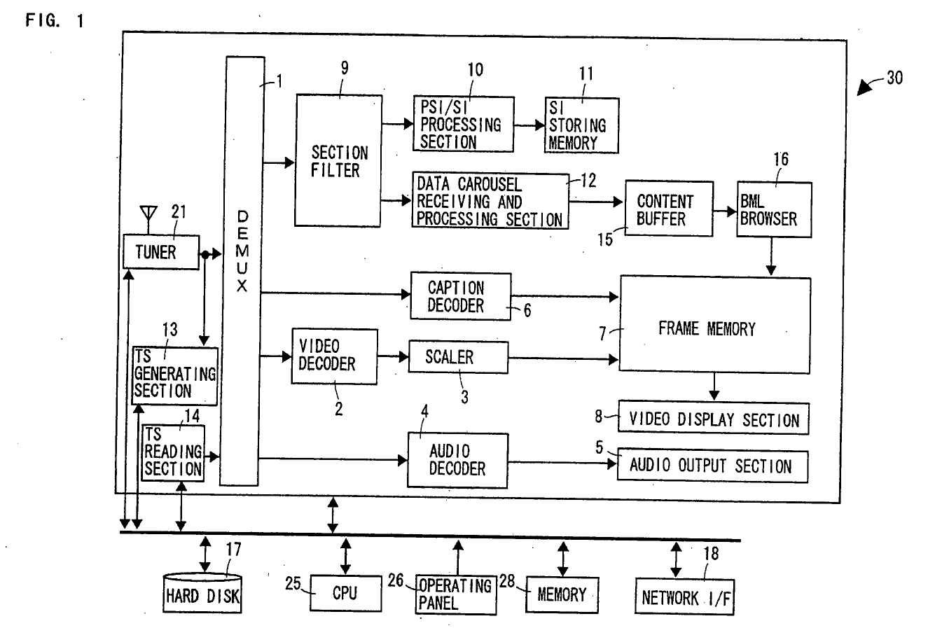

An embodiment of the present invention will be described below with reference to FIGS. 1 to 8.

In FIG. 1, a tuner 21 receives terrestrial wave and selects digital modulation signals, for example. Further, the tuner 21 comprises a demodulation circuit, an inverse interleave circuit, an error correcting circuit and so on, thereby demodulating the selected digital modulation signal and outputting a transport stream (TS).

A received program (the transport stream) is stored as a recorded file in a hard disk driver 17. A TS generating section 13 receives the transport stream from the tuner 21, and records the transport stream into the hard disk driver (HDD) 17. Furthermore, the TS generating section 13 is able to remove needless TS packets (NULL packets, packets of an unnecessary television program, and so on) in that recording or is able to record only packets of a selected program (a service). The TS generating section 13 is controlled by a CPU (Central Processing Unit) 25. Note that the hard disk driver 17 is also able to store video and audio data of the received program, instead of the transport stream of the received program Saved data of the video and audio of the received program or saved transport stream of the received program is referred to as a video file. In this regard, a video file that is saved temporarily is referred to as a temporarily video file, and a video file that is saved permanently is referred to as a reference file, as described as follows.

In reproducing processing, a TS reading section 14 reads out a video file (stream) from the hard disk driver 17 to feed the video file to a demultiplexer (DEMUX) 1. The TS reading section 14 is controlled by the CPU 26.

The demultiplexer 1 separates the transport stream from the tuner 21 or the transport stream from the TS reading section 14 into a video stream and an audio stream based on MPEG (Moving Picture Experts Group4) and section data. A section filter 9 separates the section data into PSI/SI (Program Specific Information/Service Information) and data carousel.

An audio decoder 4 decodes the TS packets outputted from the demultiplexer 1 and generates an audio signals by means of D/A (digital-to-analog) conversion processing to feed the audio signals to an audio output section 5 (speaker etc.,). A video decoder 4 decodes the TS packets which have been inputted, to find a quantization factor and a motion vector, thereby carrying out inverse DCT (Discrete Cosine Transformation), motion compensation control based on the motion vector, and the like, and outputs video data. A scaler 3 inputs the video data and controls the size of an image, a graphic mode and so on. A caption decoder 6 decodes caption data in the stream to generate character data.

A PSI/SI processing section 10 inputs the PSI/SI and extracts information used in EPG (Electronic Program Guide) etc., from the PSI/SI. A SI storing memory 11 stores the information. A data carousel receiving and processing section 12 processes the data carousel separated by the section filter 9 to acquire a data broadcast content, and feeds the data broadcast content to a content buffer 15. The content buffer 15 temporarily stores the data broadcast content and updates the data broadcast content.

A BML (Broadcast Markup Language) browser 16 is activated in a case where the data broadcast program is displayed. Data displaying processing in a dependent data broadcasting is performed when a key operation such as operation of a data broadcast displaying key (a d-key) is detected. In the data broadcasting, processing to extract a start-up module (module ID=0) contained in an entry component is attempted, and screen displaying is carried out based on an obtained start-up content. Display processing of a lower layer file is carried out by user's operation of various buttons (“Weather Report”, “News” etc.,) provided on a start-up screen.

The BML browser 16 requests a content (data) to be displayed the content buffer 15. The content buffer 15 sends requested data if the requested data is presented in the content buffer 15. If the requested data is not presented in the content buffer 15, the data carousel receiving and processing section 12 extracts the requested data from the transport stream. The data carousel receiving and processing section 12 extracts data being transported in the form of DSM-CC (Digital Storage Media Command and Control).

A frame memory 7 inputs the received video data from the scaler 3, the caption data from the caption decoder 6, and data from the BML browser 16, and creates respective image planes based on these data to generate combined image data, and feeds the combined image data to a video display section (a liquid crystal display etc.,) 8. An OSD (On screen display) circuit (not shown) generates video data based on character information and color information which it is instructed to output from the CPU 25, and feeds the video data to the frame memory 7. The frame memory 7 interposes the video data in the received video data outputted from the scaler 3 and so on.

An operating panel 26 is provided with a power-on key, a cross key (arrow keys), channel number keys, a TV-on key, a recording key, a playback key, an Enter key and so on.

A memory (RAM (Random Access Memory), EEPROM (Erasable Electrically Programmable Read-Only Memory), Flash Memory etc.,) 28 stores various programs, various data, and so forth.

Although the CPU 25 carries out overall control in the reception device, it performs processing as follows. Here, the CPU 25 functions as a browser that interprets HTML (Hyper Text Markup Language) file, and is able to access the Internet via a network interface 18 to carry out displaying of an image of a received HTML file.

(1) In a state where the reception device is receiving television broadcast signals, the CPU 25 outputs a recording command to the TS generating section 13 so that a received transport stream is recorded in the hard disk driver 17. One mode of processing of the recording command is a mode to record a temporarily video file consisting of a transport stream of 1-minute play duration, for example. Another mode of processing of the recording command is a mode to keep the last five temporarily video files and to delete the oldest temporarily video file out of the five temporarily video files when a new temporarily video file is created. With the aforementioned another mode, received video and audio (transport stream) of 5-minutes play duration from a certain point are kept all the time. Needless to say, received video and audio data obtained by the decoding may be recorded in the hard disk driver 17 in the same manner as described above instead of the recording of the transport stream. A basic recording time period of the temporarily video file and the number of temporarily video files (a total time period) is exemplified, the present invention is not limited to the aforementioned example. Further, a file name is given to each temporarily video file using date and time information of the start point of recording of the temporarily video file, for example. For example, a file name such as “20060322_{—}100530.ts” is given to a temporarily video file, if the start point of recording of the temporarily video file is 10:05:30 am on Mar. 22, 2006.

Note that the temporarily video file is a video file that is temporarily recorded. Therefore, the temporarily video file is deleted except the case where the temporarily video file becomes a reference file described as follows. Furthermore, when a channel is changed, it is allowed to delete all temporarily video files that have been recorded and to create a new temporarily video file.

(2) The CPU 25 checks a signal from the operating panel 26 or from a remote controller (not shown) during reception of television broadcasting, and judges whether on not a chapter command (video clip demand) is outputted by a user. The CPU 25 transfers image data (a screen image) that is written in the frame memory 7 to the hard disk driver 17 as a partial saved file (a received partial information) when the chapter instruction is issued. A file name is given to the partial saved file using date and time information of the start point of recording of the partial saved file, for example. For example, a file name such as “20060322_{—}100530.jpg” is given to the partial saved file, if the start point of recording of the partial saved file is 10:05:30 am on Mar. 22, 2006.

(3) When the chapter instruction is issued, the CPU 25 further stores a total of five temporarily video files including a temporarily video file which is in process of creation at a time of receiving the chapter instruction, for example, in another area for saving in the hard disk driver 17 and so on as a reference file which is treated as permanent recording. Furthermore, the CPU 25 relates the partial saved file to the reference file. This relating (relevant information) is to have information, the information indicating whether or not the reference file is present relating to the partial saved file and teaching a file name of the reference file if the reference file is present and indicating where the reference file is saved, for example. FIG. 3 shows an example of a linking file relating the partial saved file to the reference file. The linking file in FIG. 3 is composed of a date and time of creation, a name of the partial saved file, a name of the reference file, and offset time information. The date and time of creation is information of a date and time of creation of the partial saved file, and the offset time information is a difference between the date and time of creation of the partial saved file and a creating start date and time of the reference file.

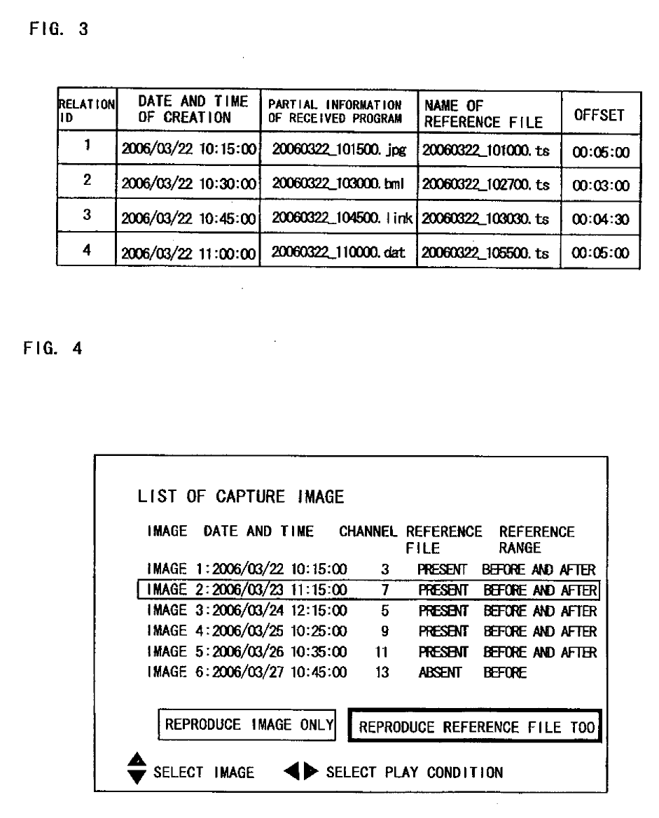

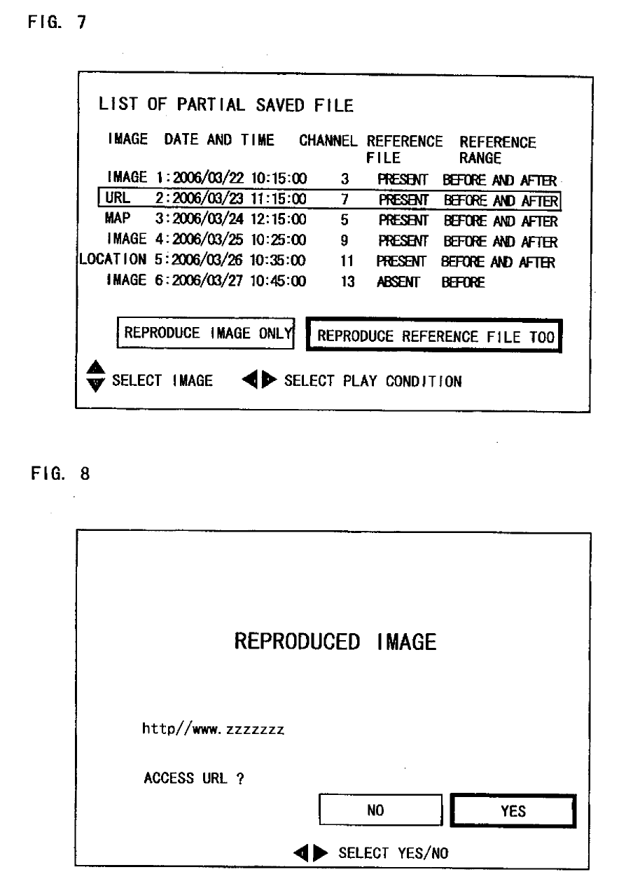

(4) When a request for viewing a list of the partial saved file is issued, the CPU 25 retrieves the partial saved file that is saved in the hard disk driver 17, and displays information obtained by the retrieving on a screen of the reception device by using an OSD function. FIG. 4 shows an example of a displayed list. In the list shown FIG. 4, only capture images are extracted from the partial saved file, and the caption images are displayed. Note that the CPU 25 may display a screen that is used by a user to select a specific file type in advance of showing a list composed of only the partial saved file belonging to said specific file type. Or the CPU 25 may display a list without classifying based on the file type, as shown FIG. 7.

(5) The CPU 25 displays a cursor for pointing a desired saved file on the screen displaying the list. The CPU 25 further detects an operation signals of the keys of the operating panel 26 or of the remote controller, and moves the cursor in accordance with the operation signals of the keys. The CPU 25 judges whether or not the Enter key is depressed. When judged that the Enter key is depressed, the CPU 25 reproduces the partial saved file (e.g., a still image is displayed on the screen) on which the cursor is placed at a time when the Enter key is depressed. The CPU 25 further reproduces the partial saved file and displays a message such as “There is a reference file. Play back? YES/NO” by using an OSD function. The CPU 25 can judge whether or not the reference file is present based on the aforementioned relevant information. If the user selects “YES”, the CPU 25 identifies the reference file based on the relevant information, and reproduces (plays back) the identified file. The TS reading section 14 is used for reading the transport stream from the hard disk driver 17. The CPU 25 displays a window on the screen displaying the partial saved file by reproducing, and reproduces the reference file to display the reference file in the window. With this processing, a still image, for example, of a certain scene of a certain program, which is the partial saved file, is displayed on the whole screen, and a partial moving image of said certain program, which is the reference file, is displayed in the window. If the partial moving image is a reference file of 5-minutes play duration, a program video of 5-minutes play duration that includes the certain scene (the still image) is displayed in the window. Therefore, it is possible to reproduce the recorded content (the reference file) in conjunction with the reproducing of the received partial information (the partial saved file), and the user can remember the reason why the received partial information (the partial saved file) was stored. That is, the user can remember the program (TV Show) relative to the received partial information (the partial saved file) being reproduced.

It is possible to save a data broadcast program as the partial saved file. The data broadcast program that is saved may contain not only a BML content but also a still image data, a BML content existing on a linked page, and a data file that are referred in the BML content. For example, there is a case where a salesperson sells commodities by video and audio in a television shopping program, and a data broadcast program shows a screen presenting commodities by a still image (a cross-section drawing of an article etc.,) and a character information. When the user gives an instruction to record information in the broadcast program (for example, (1) in a state where a cursor is placed on an object image, the user depresses a “Preservation” button or (2) when a cursor of a pointing device (a mouse) is placed on an object image, a “Preservation” and “Print” items are displayed, and the user operates the “Preservation” item) to the reception device, the CPU 25 records the whole content of the BML content or a part of the BML content as the partial saved file, and transfers and saves a total of five temporarily video files into another area for saving in the hard disk driver 17 as a reference file which is treated as permanent recording. Note that, when the user gives the recording instruction to the reception device, the CPU 25 displays messages such as “Cursor?”, “Whole?”, and “Linked page?”, and accepts a request from the user. The message “Cursor?” denotes a character string on which a cursor is placed is saved. The message “Whole?” denotes that data of the whole screen is saved. The message “Linked page?” denotes a still image which is referred as a linked page and a BML content of the linked page are saved. When the message “Linked page?” is selected, the CPU 25 accesses the linked page to receive the BML content.

Then, the CPU 25 relates the partial saved file to the reference file. Therefore, in a case where a still image (a cross-section drawing of an article etc.,) in the television shopping program is saved, it is possible to reproduce not only the still image but also video and audio as to the presenting of commodities.

It is allowed to store link information that is incorporated in the data broadcast content as the partial saved file. The link information including a linked page which is a primary link or a secondary link necessary for linking is described in URL (Uniform Resource Locator). Therefore, it is preferable to save the URL. Furthermore, It is preferable to acquire the BML content according to the secondary link and to save image information (a still image data) generated from the BML content for the purpose of adequacy of showing the partial saved file. Similarly to above, there is a case where the salesperson sells commodities by video and audio in the television shopping program, and the data broadcast program shows link information indicating a link page (a purchase order page), in addition to the screen presenting commodities by the still image and the character information. When the user performs an operation for requesting to save information in the broadcast program (for example, in a state where a cursor is placed on an object image, the user depresses a “Preservation” button) to the reception device, the CPU 25 records the URL as the partial saved file, and transfers and saves a total of five temporarily video files into another area for saving in the hard disk driver 17 as the reference file. Then, the CPU 25 relates the partial saved file (the URL) to the reference file. Therefore, in a case where the URL is saved, it is possible to reproduce not only the URL but also video and audio as to the presenting of commodities.

It is allowed to record location information existing in the specification information of the data broadcast program as the partial saved file. Furthermore, in a case where the location information and map data involving the location information are presented, the map data also may be saved. For example, in a case where the television broadcast is received by a reception device having a car navigation system, and when the user gives an instruction to record the location information in the data broadcast program (for example, in a state where a cursor is placed on a section on which a description such as “80° E longitude in latitude 40° N” is displayed or is placed on an address description section, the user depresses a “Preservation” button) to the reception device, the CPU 25 records the location information as the partial saved file, and transfers and saves a total of five temporarily video files into another area for saving in the hard disk driver 17 as the reference file which is treated as permanent recording. Then, the CPU 25 relates the partial saved file to the reference file. For example, there is a case where the user wants to save location information of a tourist spot, when the location information of the tourist spot is incorporated in a data broadcast program on which a content concerning the tourist spot is presented. However, there is a case where the user forgets what kind of tourist spot it is, even though the user views only the location information (and/or the map image) later. As described above, if the reference file is saved so that the reference file is related to the location information, the user can remember the reason why the location information was stored. Note that, it is desirable that the location information is information having a form that can be used as location inform that is used for goal setting in the car navigation system. Furthermore, the car navigation system may display a list composed of the location information received from a terrestrial digital broadcast, and accept the goal setting on this list.

It is allowed to save obtainable information by downloading using a broadcast currently being received. As the obtainable information (an obtainable content), there are a game software file, a music file and so on. For example, there is a case where video and audio are broadcasted in a popular song program, and a music file as to a singer singing a song at that time in the popular song program is transmitted using a data carousel method. When the user gives an instruction to download the music file (for example, a button such as “Purchase” button is selected) to the reception device, the CPU 25 downloads and records the music file as the partial saved file, and transfers and saves a total of five temporarily video files into an another area for saving in the hard disk driver 17 as a reference file which is treated as permanent recording. Then, the CPU 25 relates the partial saved file to the reference file. Even though in a case where the user forgets the artist whose songs are downloaded, the user can remember the artist by reproducing the reference file.

In creation of the partial saved file, for the purpose of indicating outline of the partial saved file, it is allowed to save character information so that the character information is related to the partial saved file. The character information contains a title of a program, genre information and so on. For example, in a case where a title of the program is “Gourmet trip” and the partial saved file is the URL, an expression such as “Gourmet trip=Http.www.zzz” is adopted as a relational expression. Further, in a case where a still image is saved, the caption data may be saved as the character information. Furthermore, the offset time information shown in FIG. 3 may be saved as the character information. In a case where data of the data broadcast program is saved as the partial saved file, the title of the data broadcast program may be saved as the character information. The title of the data broadcast program is described in a title tag of a head tag. The preservation of the link information is not limited to the preservation of the URL, and if it is possible to use a title of the link page as the link information, the title may be saved as the linked page.

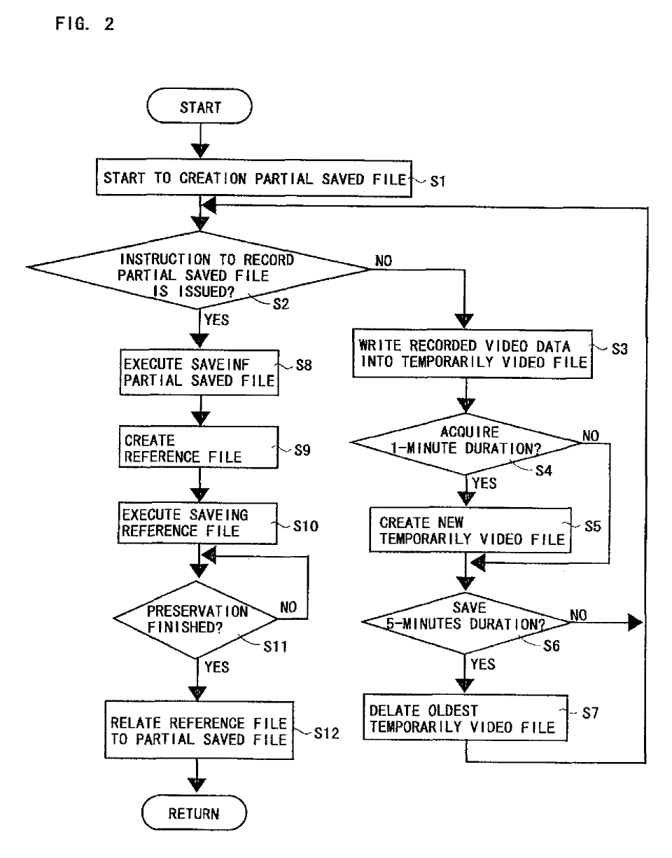

FIG. 2 is a flow chart showing a save processing of the CPU 25. The CPU 25 starts to receive broadcast waves and starts to create a temporarily video file (step S1), and judges whether or not an instruction to create a partial saved file is issued (step S2). The instruction to create a partial saved file is outputted by depressing a button for acquiring a capture image or depressing a “Preservation” button in a state where a cursor is placed on a place where URL is described. If it is judged in step S2 that the instruction to create the partial saved file is not issued, the CPU 25 writes video data to the temporarily video file. Next, the CPU 25 judges whether or not the size of the temporarily video file reaches the data amount of 1-minute play duration (step S4). If it is judged in step S4 that the size reaches the data amount, the CPU 25 creates a new temporarily video file (step S5). On the contrary, if it is judged in step S4 that the size does not reach the data amount, the CPU 25 judges whether or not the size of the total of the temporarily video files reaches the data amount of 5-minutes play duration (step S6). If it is judged in step S6 that the size does not reach the data amount, the process returns to step 2. On the contrary, if it is judged in step S6 that the size reaches the data amount, the CPU 25 deletes the oldest temporarily video file, and the process returns to step 2.

If it is judged in step S2 that the instruction to create the partial saved file is issued, the CPU 25 carries out to create the partial saved file (step S8). Further, the CPU 25 carries out to create a reference file by combining the temporarily video files of 5-minutes play duration each other (step S9), and saves the reference file (step S10). Next, the CPU 26 judges whether or not the saving process is finished (step S11). If the saving process is finished, the CPU 25 relates the reference file to the partial saved file.

When the partial saved file is displayed (is played back), the CPU 26 reads out the partial saved file from the hard disk driver 17, and displays the partial saved file. Further, the CPU 25 retrieves the reference file related to the partial saved file based on the linking file shown in FIG. 3. If the reference file related to the partial saved file is found, the CPU 25 displays a message indicating a presence of the reference file. When the CPU 25 detects an indication to display the reference file from the user, reproduces (plays back) and displays the reference file. Needless to say, when the CPU 25 finds the reference file related to the partial saved file, the CPU 25 may reproduce the reference file related to the partial saved file without detecting an indication to display the reference file from the user.

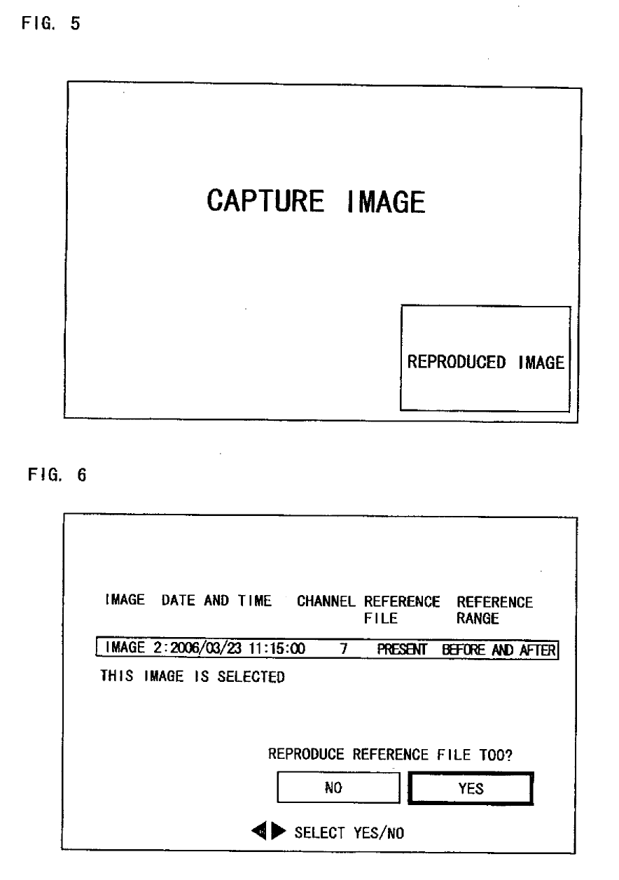

In FIG. 4 that is exemplified as the list of the partial saved file, the user can select the desired capture image (an item) by operating the up and down arrow keys. Furthermore, the user selects ether a “Reproduce only image” button or a “Reproduce reference file too” button. When the “Reproduce reference file too” button is selected and the Enter key is depressed, the CPU 25 displays the capture image, as shown in FIG. 5, and displays the reference file related to the partial saved file, and displays a reproduced image of the reference file by using a function of picture-in-picture.

Note that, in the screen shown FIG. 4, it is allowed to omit the “Reproduce only image” button and the “Reproduce reference file too” button. In this case, the reception device may ask the user whether or not he or she wants to reproduce the reference file by displaying a determined item, as shown FIG. 6.

In FIG. 7 that is exemplified as the list of the partial saved file, a state where the URL is selected as the partial saved file is shown. In a state as shown in FIG. 7, if the Enter key is depressed, the reference file is reproduced and displayed, and a character string in the URL is displayed by using the OSD function, as shown FIG. 8, for example. With such a display function, the user can remember the reason why the URL was saved by seeing the reproduced image. If the user selects the “YES”, the CPU 25 receives a HTML file, by using the network interface 18, from a resource that is indicated by the URL, to display the HTML file. Note that, in a screen as shown in FIG. 7, at the timing when the cursor is placed on the item (at the timing when the item is selected), the reception device may automatically display the reference file by using the function of picture-in-picture. That is, at the time when the partial saved file is selected (in a stage where the partial saved file is not reproduced yet), the reference file may be reproduced. If the user recognizes that the selected item is the desired partial saved file because seeing the reference file, the user depresses the Enter key. By depressing the Enter key, processes such as process to reproduce (display) the partial saved file, process to access to a linked page based on the partial saved file, and process to set the goal in the car navigation system by using the location information based on the partial saved file are carried out.

Note that, in the aforementioned embodiments, a total of five temporarily video files (5-minutes play duration) are usually created, and when the partial saved file is created, the temporarily video file becomes the reference file which is treated as permanent recording. Therefore, a content of the broadcast that is received a little before the creation of the partial saved file becomes the reference file. The present invention is not limited thereto. For example, if the CPU 25 continuously creates a video file composed of a total of e.g. five temporarily video files after the start of the creation of the partial saved file, a content of the broadcast that is received a little after the start of the creation of the partial saved file also becomes the reference file. Needless to say, it is allowed to create the reference file that is composed only of a content of the broadcast that is received a little after the start of the creation of the partial saved file. The user may select in advance either the partial saved file (either the operation mode). Further, in a case where the partial saved file is created immediately after changing channels, there is a case where a recording period of the partial saved file is not enough. In this case, it is allowed to create the reference file by using a broadcast content after a time when the partial saved file is created.

Note that, in the aforementioned embodiments, the list of the partial saved file is displayed, but the present invention is not limited thereto. For example, messages such as “This partial saved file was created last week. Do you watch this file?” are displayed, and when the user performs an operation to watch the partial saved file, the partial saved file may be reproduced.

As a digital broadcast reception device, the stationary receiver is disclosed, but it may be a portable receiver, a mobile phone having a function to receive a terrestrial digital broadcast, a terrestrial digital broadcast reception device having car navigation system, and a personal computer having a terrestrial digital broadcast board and a driver software for said board.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A digital broadcast reception device, comprising:
a tuner for receiving a digital broadcasting to output a transport stream;
a demultiplexer for separating packets from the transport stream;
a decoder for decoding the packets to output data;
an output section for outputting video and audio of a program based on the data obtained by the decoder;
a recorder for recording video and audio data in a program being displayed at present or a transport stream containing video and audio data in a program being displayed at present;
an information recording section for recording received partial information has been obtained or received partial information being obtained by reception broadcast at a time when the reception device receives an instruction to record from a user;
a recording controller for relating the received partial information to a recorded content recorded by the recorder when the received partial information is recorded by the information recording section, the recorded content being a content of the broadcast that comes before and after or before or after the received partial information that is recorded; and
a reproducing controller for showing the recorded received partial information and reproducing the recorded content recorded in the recorder.

2. The digital broadcast reception device according to claim 1, wherein, the recording controller acquires, from information included in the broadcast currently being received, character information indicating as to which program the received partial information belongs to, and relates the character information to the received partial information.

3. The digital broadcast reception device according to claim 1 or 2, wherein, the received partial information is an image that is captured at a time when the reception device receives an instruction to record from a user.

4. The digital broadcast reception device according to claim 1 or 2, wherein, the received partial information is at least one of specification information existing in a data broadcast program, link information existing in the specification information, and location information existing in the specification information.

5. The digital broadcast reception device according to claim 1 or 2, wherein, the received partial information is information that is downloaded using the broadcast currently being received.

6. The digital broadcast reception device according to claim 1 or 2, further comprising, a list display controller for displaying a list that relates the received partial information to the recorded content.

7. The digital broadcast reception device according to claim 1 or 2, wherein, the reproducing controller automatically displays the recorded content related to the received partial information when the received partial information is displayed or is selected by user's operation.

8. The digital broadcast reception device according to claim 1 or 2, wherein, the reproducing controller is display a message indicating that the recorded content according to the received partial information is saved when the received partial information is displayed or is selected by user's operation, and display the recorded content when an operation indicating that the user wishes to view the recorded content is performed by the user.

9. A digital broadcast receiving method for recording information, the method comprising the steps of
(a) receiving a digital broadcasting to output a transport stream;
(b) separating packets from the transport stream;
(c) decoding the packets to output data;
(d) outputting video and audio of a program based on the data obtained by the decoding;
(e) recording video and audio data in a program being displayed at present or a transport stream containing video and audio data in a program being displayed at present;
(f) recording received partial information has been obtained or received partial information being obtained by reception broadcast at a time when a reception device receives an instruction to record from a user;
(g) relating the received partial information to a recorded content when the received partial information is recorded, the recorded content being a content of the broadcast that comes before and after or before or after the received partial information that is recorded; and
(h) showing the recorded received partial information and reproducing the recorded content.
